(19) United States
(12) Patent Application Publication
(10) Pub. No.: US 2014/0182077 A1
(43) Pub. Date: Jul. 3, 2014

(54) Wiper Arm Apparatus Having Improved Lock-Back Structure

(71) Applicant: Dongyang Mechatronics Corp., Incheon (KR)

(72) Inventors: Tae Hun Ju, Incheon (KR); Kyoung Ho Ko, Incheon (KR)

(73) Assignee: Dongyang Mechatronics Corp., Incheon (KR)

(21) Appl. No.: 14/060,973

(22) Filed: Oct. 23, 2013

(30) Foreign Application Priority Data
Dec. 28, 2012 (KR) 10-2012-0156938

(51) Int. Cl. B60S 1/34

(52) U.S. Cl. CPC B60S 1/3456
USPC 15/250.351

(57) ABSTRACT

A wiper arm apparatus having an improved lock-back structure includes: an arm head; a retainer; and a spring that elastically couples the retainer to the arm head, wherein the retainer includes a protruding hooking unit, which protrudes toward the arm head in a direction of a length of the retainer, and the arm head includes: a rotation guide unit which allows the retainer to rotate around the arm head by preventing the protruding hooking unit from being interfered with; an arm stopper unit which is disposed at an end of the rotation guide unit and by which the protruding hooking unit is hooked, so as to restrict a rotation angle of the retainer; and a stopper cover unit that is extended to and formed at the arm head, and forms a structure that covers the rotation guide unit and the arm stopper unit.

### RELATED APPLICATIONS

This application claims the benefit of Korean Patent Application No. 10-2012-0156938, filed on Dec. 28, 2012, in the Korean Intellectual Property Office, the disclosure of which is incorporated herein in its entirety by reference.

### BACKGROUND

1. Field

One or more embodiments of the present invention relate to a lock-back structure of a wiper arm.

2. Description of the Related Art

Generally, a wiper apparatus, installed in a vehicle, includes a wiper blade at an end of a wiper arm. As the wiper arm performs a rotation motion, the wiper apparatus removes foreign substances on a glass windshield of the vehicle, and thus, ensures a driver's view. With regard to such a wiper apparatus, a wiper arm apparatus is a structure that delivers a rotation motion to a wiper blade through rotation of a motor which is installed in a vehicle. That is, the wiper arm apparatus includes an arm head, which is fixed to a pivot shaft that is installed in the vehicle, and a retainer, which is assembled with the arm head so that the retainer may rotate around the arm head within a range of a certain angle. The wiper blade is assembled at a free end of the retainer. The retainer is installed so as to rotate around the arm head, so that the wiper blade may be replaced or repaired in a state that the wiper apparatus is installed in the vehicle. Additionally, an elastic recovering force is exerted on the retainer and the arm head in a direction that the wiper blade presses a glass windshield of the vehicle by using a spring. According to a relative location between the retainer and the arm head, the spring may exert an elastic recovering force in a direction that the retainer becomes away from the windshield of the vehicle. Such a state is defined as a lock-back state. The lock-back state is needed when the wiper blade is to be replaced or repaired. In the lock-back state, the retainer and the arm head contact each other. Since the retainer and the arm head are manufactured of metal, if the retainer and the arm head contact each other, a coated surface of a contact area may be damaged. If the lock-back state is repeated, and thus, the surface of the contact area is damaged, the damaged surface may be corroded and discolored. Thus, appearance of the vehicle may become inaesthetic, and a user may make a complaint.

An example of a wiper arm, provided to solve such a problem, is disclosed in Korean Patent Publication No. 0773708. However, a lock-back structure, disclosed in Korean Patent Registration No. 0773708, provides a structure in which a location of a contact between a retainer and an arm head is changed. Thus, an area of the contact is exposed to a user's view, and this may eventually cause user dissatisfaction. Therefore, emotional quality, which has been recently emphasized, may not be ensured.

The present invention is to solve such a problem. A lock-back structure of a vehicle wiper arm apparatus is enhanced, and thus, an area of a contact between a retainer and an arm head in a lock-back state may not be exposed to a user's view. Accordingly, user dissatisfaction may be prevented, and emotional quality of the wiper arm apparatus may be enhanced.

### SUMMARY

Additional aspects will be set forth in part in the description which follows and, in part, will be apparent from the description, or may be learned by practice of the presented embodiments.

According to one or more embodiments of the present invention, a wiper arm apparatus having an improved lock-back structure, the wiper arm apparatus includes an arm head that is fixed to a pivot shaft of a vehicle; a retainer that is rotatably assembled at an end of the arm head and connected to a wiper blade; and a spring that elastically couples the retainer to the arm head, wherein the retainer includes a protruding hooking unit, which protrudes toward the arm head in a direction of a length of the retainer, at an end side of a portion in which the retainer is coupled to the arm head, and the arm head includes: a rotation guide unit which allows the retainer to rotate around the arm head by preventing the protruding hooking unit from being interfered with; an arm stopper unit which is disposed at an end of the rotation guide unit and by which the protruding hooking unit is hooked, so as to restrict a rotation angle of the retainer; and a stopper cover unit that is extended to and formed at the arm head, and forms a structure that covers the rotation guide unit and the arm stopper unit, so that the rotation guide unit and the arm stopper unit are not seen from outside, wherein the stopper cover unit is formed as one body with the arm head.

The arm stopper unit may have a structure in which the stopper cover unit is connected to a sidewall of the arm head, and may be formed as one body with the stopper cover unit.

The arm stopper unit may be formed as a pin, which fixes the spring to the arm head, protrudes toward and extends to an outer side of the arm head.

The protruding hooking unit may be formed as one body with a side of the retainer.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic perspective view of a wiper arm apparatus according to an embodiment of the present invention;

FIG. 2 is a partial cross-sectional view of an area “A” shown in FIG. 1;

FIG. 3 is a diagram illustrating a lock-back state in correspondence with FIG. 2;

FIG. 4 is a diagram illustrating another embodiment of the present invention in correspondence with FIG. 2; and

FIG. 5 is a diagram illustrating a lock-back state in correspondence with FIG. 4.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

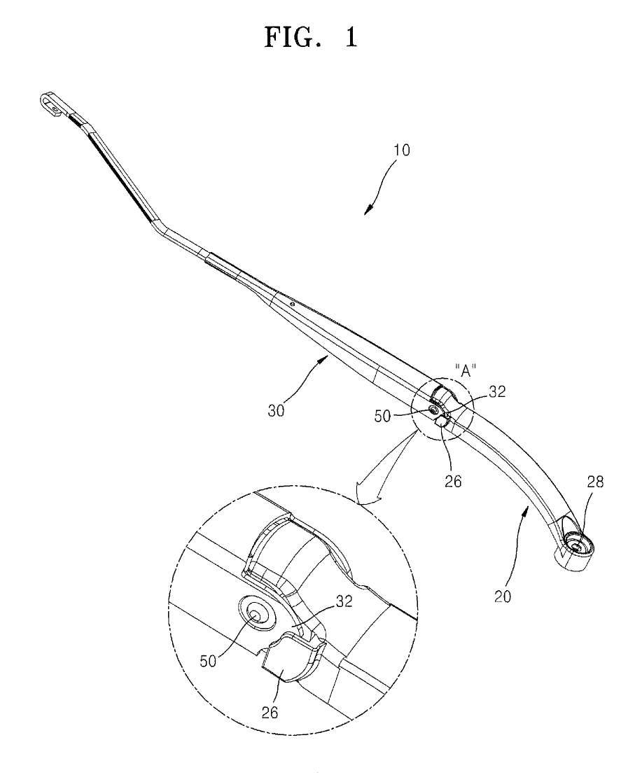

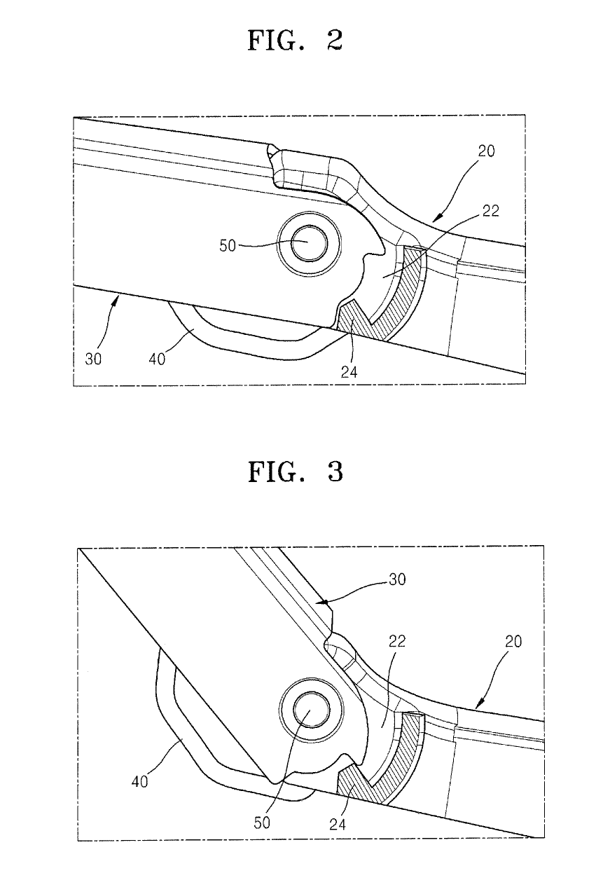

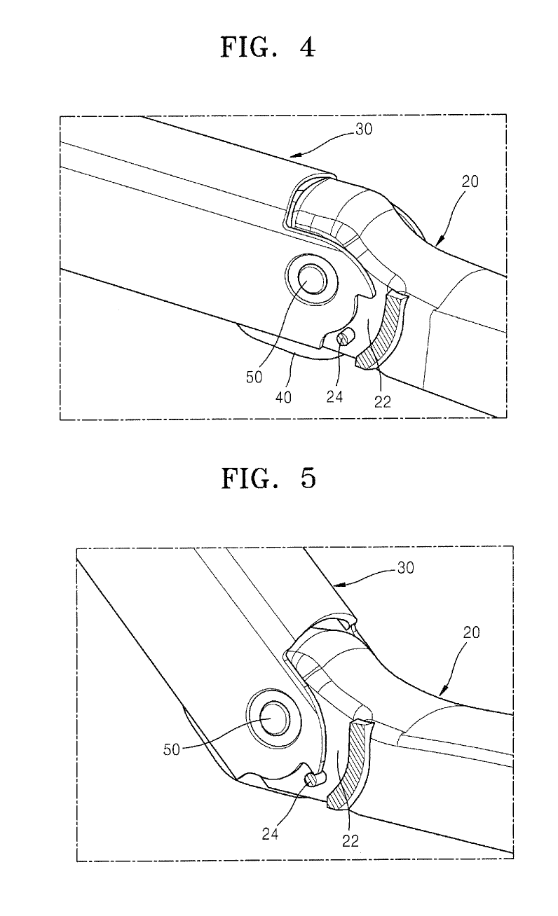

FIG. 1 is a schematic perspective view of a wiper arm apparatus according to an embodiment of the present invention. FIG. 2 is a partial cross-sectional view of an area “A” shown in FIG. 1. FIG. 3 is a diagram illustrating a lock-back state in correspondence with FIG. 2. FIG. 4 is a diagram illustrating another embodiment of the present invention, in correspondence with FIG. 2. FIG. 5 is a diagram illustrating a lock-back state in correspondence with FIG. 4.

Referring to FIGS. 1 through 5, according to an embodiment of the present invention, a wiper arm apparatus 10 having an enhanced lock-back structure, hereinafter referred to as a wiper arm apparatus, is an apparatus that is installed in a vehicle and helps safe driving by ensuring a driver's view.

The wiper arm apparatus 10 includes an arm head 20, a retainer 30, and a spring 40.

The arm head 20 is a stick-shaped member that is fixed to a pivot shaft (not illustrated) which is installed in a vehicle. A rotation shaft 50 is installed at one end of the arm head 20 so as to be rotatably coupled to the retainer 30 that will be described later. The rotation shaft 50 protrudes to an outside of both sidewalls of the arm head 20, and thus, is coupled to the retainer 30. The arm head 20 and the retainer 30 are coupled to each other in a rotatable structure via the rotation shaft 50.

A coupling hole 28 is included at the other end of the arm head 20 so that the arm head 20 may be fixed to the pivot shaft. The arm head 20 is coupled to the pivot shaft via the coupling hole 28 and fixed to the pivot shaft by using a fixing element such as a cap nut.

The retainer 30 is rotatably assembled with the end of the arm head 20. That is, the retainer 30 is rotatably coupled to the arm head 20 via the rotation shaft 50. A wiper blade (not illustrated) is connected to a free end of the retainer 30.

The spring 40 elastically couples the retainer 30 to the arm head 20. A tensile-coil spring may be employed as the spring 40. One end of the spring 40 is coupled to the arm head 20, and the other end of the spring 40 is coupled to the retainer 30. According to a relative location of both sides of the spring 40, an elastic recovering force may be exerted on the retainer 30 in a direction in which the retainer 30 is pressed toward a vehicle windshield, or in a direction in which the retainer 30 becomes away from the vehicle windshield. In this case, an elastic recovering force is exerted on the retainer 30 in a direction in which the retainer 30 becomes away from the vehicle windshield. Thus, rotation of the retainer 30 is restricted by the arm head 20, and the retainer 30 is fixed at a certain location. This is referred to as a lock-back state. In the lock-back state, a wiper blade may be repaired or exchanged.

The present invention provides a structure that forms the lock-back state. Hereinafter, a feature of the present invention will be specifically described.

The retainer 30 includes a protruding hooking unit 32.

The protruding hooking unit 32 is disposed at an end side of a portion of the retainer 30 to which the arm head 20 is coupled. The protruding hooking unit 32 protrudes in a direction of a length of the retainer 30. More specifically, the protruding hooking unit 32 is formed as one body with a side of the retainer 30. Accordingly, an additional forming process, in a conventional process of manufacturing a retainer, is not needed so as to form the protruding hooking unit 32, and only a trimming die needs to be changed. The protruding hooking unit 32 protrudes toward the arm head 20.

The arm head 20 includes a rotation guide unit 22, an arm stopper unit 24, and a stopper cover unit 26.

The rotation guide unit 22 is a space that is provided so that the protruding hooking unit 32 is not interfered with when the retainer 30 is rotating around the arm head 20. The rotation guide unit 22 is formed in the form of a circular arc that has a center on the rotation shaft 50.

The arm stopper unit 24 is disposed at an end of the rotation guide unit 22. The arm stopper unit 24 has a structure which is formed so that the protruding hooking unit 32 is hooked by the arm stopper unit 24. The arm stopper unit 24 restricts a rotation angle of the retainer 30. As shown in FIGS. 2 and 3, the arm stopper unit 24 may be formed to protrude outside from a sidewall of the retainer 30. The arm stopper unit 24 may form a structure in which the sidewall of the arm head 20 is connected to the stopper cover unit 26 that will be described later. If formed to be connected to the stopper cover unit 26, the arm stopper unit 24 may function as a structure for supporting the stopper cover unit 26, thus improving durability of a wiper arm structure.

As shown in FIGS. 4 and 5, the arm stopper unit 24 may be formed by extending a pin that is provided on the arm head 20 so as to fix the spring 40 to the arm head 20. That is, the arm stopper unit 24 may be formed by extending an end of the pin, which is provided on the arm head 20, so as to fix the spring 40 to the arm head 20 so that the pin protrudes and extended toward an outer side of the arm head 20.

The stopper cover unit 26 is extended and formed at the arm head 20. The stopper cover unit 26 forms a structure for covering the rotation guide unit 22 and the arm stopper unit 24 so that the rotation guide unit 22 and the arm stopper unit 24 are not seen from outside. The stopper cover unit 26 functions as a cover so that the protruding hooking unit 32 and the arm stopper unit 24 are not seen from outside when the retainer 30 is rotating between a lock-back state and a normal state. The stopper cover unit 26 is formed as one body with the arm head 20. For example, the stopper cover unit 26 may be manufactured by using an aluminum die-casting method or a casting method.

Hereinafter, a working effect of the wiper arm apparatus 10, which has the structure described above, will be described in detail.

Referring to FIGS. 2 and 3, the wiper arm apparatus 10 in the present invention may shift between a normal state and a lock-back state. If the wiper arm apparatus 10 is installed in a vehicle and removes a foreign substance on a glass windshield, as shown in FIG. 2, the wiper arm apparatus 10 is in a normal state. If it is necessary to replace or repair a wiper blade, as shown in FIG. 3, the wiper blade is repaired or replaced in a lock-back state. In a lock-back state, the retainer 30 rotates around the arm head 20, and thus, the protruding hooking unit 32 is hooked by the arm stopper unit 24. The spring 40 exerts an elastic recovering force in such a direction that the retainer 30 becomes away from a glass windshield of a vehicle. In the lock-back state, the protruding hooking unit 32 is hooked by the arm stopper unit 24, and thus, the retainer 30 and the arm head 20 directly contact each other. Accordingly, a surface of the protruding hooking unit 32 or the arm stopper unit 24 may be damaged, and corrosion on a certain area thereof may be caused. However, such corrosion may not affect working performance of the wiper apparatus. An important effect of the present invention is that the wiper arm apparatus 10 repeatedly shifts between a lock-back state and a normal state, and thus, even when corrosion on a surface of the protruding hooking unit 32 or the arm stopper unit 24 is generated, the corrosion may not be seen from outside and, accordingly, a user may not make a complaint. That is, the wiper arm apparatus 10 enhances emotional quality, and thus, provides an effect of enhancing a consumer's satisfaction. Additionally, if the protruding hooking unit 32 or the arm stopper unit 24 is exposed outside, an appearance may not be aesthetic. Thus, it may be desirable not to expose the protruding hooking unit 32 or the arm stopper unit 24 to outside. In this regard, a purpose of the present invention may be fully attained.

As described above, according to the one or more of the above embodiments of the present invention, a wiper arm apparatus is provided so that a damage on a surface, which may be caused when two elements inevitably contact each other, may not be exposed outside. Thus, emotional quality for a consumer may be enhanced.

That is, the wiper arm apparatus, having an enhanced lock-back structure, includes a stopper cover unit so that an area, in which a retainer and an arm head contact each other in a lock-back state, is not exposed to outside. Thus, the wiper arm apparatus, in which emotional quality is enhanced, may be provided.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A wiper arm apparatus having an improved lock-back structure, the wiper arm apparatus comprising:
an arm head that is fixed to a pivot shaft of a vehicle;
a retainer that is rotatably assembled at an end of the arm head and connected to a wiper blade; and
a spring that elastically couples the retainer to the arm head,
wherein the retainer comprises a protruding hooking unit, which protrudes toward the arm head in a direction of a length of the retainer, at an end side of a portion in which the retainer is coupled to the arm head, and
the arm head comprises:
a rotation guide unit which allows the retainer to rotate around the arm head by preventing the protruding hooking unit from being interfered with;
an arm stopper unit which is disposed at an end of the rotation guide unit and by which the protruding hooking unit is hooked, so as to restrict a rotation angle of the retainer; and
a stopper cover unit that is extended to and formed at the arm head, and forms a structure that covers the rotation guide unit and the arm stopper unit, so that the rotation guide unit and the arm stopper unit are not seen from outside,
wherein the stopper cover unit is formed as one body with the arm head.

2. The wiper arm apparatus of claim 1, wherein the arm stopper unit has a structure in which the stopper cover unit is connected to a sidewall of the arm head, and is formed as one body with the stopper cover unit.

3. The wiper arm apparatus of claim 1, wherein the arm stopper unit is formed as a pin, which fixes the spring to the arm head, protrudes towards and extends to an outer side of the arm head.

4. The wiper arm apparatus of claim 1, wherein the protruding hooking unit is formed as one body with a side of the retainer.
